(19) United States
(12) Patent Application Publication
(10) Pub. No.: US 2004/0124156 A1
(43) Pub. Date: Jul. 1, 2004

(54) System and method for processing waste material

(76) Inventor: James G. Davidson, Paris, TN (US)

Correspondence Address: James G. Davidson c/o Kemper Durand, Thomas, Hendrix, Harvey, Johnson & Mitchell, PLCC, 29th Floor, One Commerce Square, 40 South Main Street, Memphis, TN, 38103, US

(21) Appl. No.: 10/624,137

(22) Filed: Jul. 21, 2003

Related U.S. Application Data
(60) Provisional application No. 60/397,080, filed on Jul. 19, 2002.

(51) Int. Cl. C02F 11/12

(52) U.S. Cl. 210/768; 210/177; 210/253

(57) ABSTRACT

A system and method for processing waste material. A system according to an embodiment of the present invention comprises a grid system for separating waste material into a solid component, and a liquid and tissue component, and a centrifuge for separating the liquid and tissue component into a liquid component and a tissue component. The system further includes a mixer for mixing the solid component and the tissue component to form a solid and tissue mixture, and a hydrolizer for combining the solid and tissue mixture and superheated steam to form a cellulose material. The system further includes an extruder for extruding the cellulose material to form a construction material.

### RELATED APPLICATION(S)

This application claims the benefit of U.S. Provisional Application No. 60/397,080 filed Jul. 19, 2002.

### TECHNICAL FIELD

The present invention relates to the processing of waste material, in particular the processing of waste material to produce building or construction material.

### BACKGROUND OF THE INVENTION

A significant problem faced by the world today is that of the disposal and storage of waste material. Thus, there is a need for the recycling of waste material to produce useful products.

### SUMMARY OF THE INVENTION

One aspect of the present invention is directed to a system for processing waste material. The system includes means for separating waste material into a solid component, and a liquid and tissue component; means for separating the liquid and tissue component into a liquid component and a tissue component; means for mixing the solid component and the tissue component to form a solid and tissue mixture; means for combining the solid and tissue mixture and superheated steam to form a cellulose material; and means for extruding the cellulose material to form a construction material.

Another aspect of the present invention is directed to a method of processing waste material. The method includes the steps of separating waste material into a solid component, and a liquid and tissue component; separating the liquid and tissue component into a liquid component and a tissue component; mixing the solid component and the tissue component to form a solid and tissue mixture; combining the solid and tissue mixture and superheated steam to form a cellulose material; and extruding the cellulose material to form a construction material.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a waste processing system for processing waste material to produce construction material in accordance with an embodiment of the present invention; and

FIG. 2 illustrates a waste processing system for processing waste material to produce construction material in accordance with another embodiment of the present invention

### DETAILED DESCRIPTION

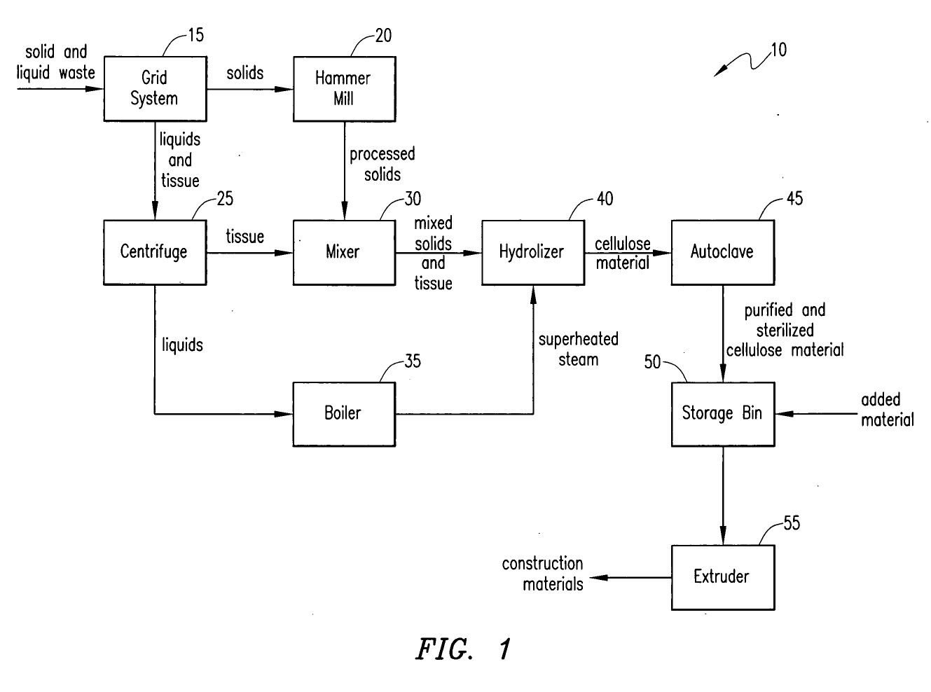

Referring now to FIG. 1, an embodiment of a waste processing system 10 for processing waste material to produce construction material is illustrated. In the waste processing system of FIG. 1, waste material having both solid and liquid components is collected and fed into a grid system 15. The waste material may be obtained from a variety of sources, such as commercial and public garbage or waste collection. The grid system 15 functions to separate larger solids having a size greater than the spaces of the grids from liquids and smaller solids in the form of tissue. The larger solids are them fed into a hammer mill 20 that is used to grind or crush the solids to form processed solid material.

The liquids and tissue from the grid system 15 are fed into a centrifuge 25 that uses a centrifugal force to separate the liquids and tissue from one another. The tissue from the centrifuge 25 and the processed solids from the hammer mill 20 are combined in a mixer 30 that mixes the processed solids and tissue together to form mixed solid and tissue material. Liquids from the centrifuge 25 are then fed into a boiler 35 that is used to produce superheated steam. In one embodiment of the present invention the superheated steam possesses a temperature of 560° F.

The mixed solid and tissue material from the mixer 30 and the superheated steam from the boiler 35 are fed into a hydrolizer 40. The hydrolizer 40 combines the mixed solid and tissue material and the superheated steam causing the material to explode into a cellulose material of fine size. The cellulose material is then fed, e.g., using sealed conveyers, into an autoclave 45 where the cellulose material is purified and sterilized to remove bacteria. The purified and sterilized cellulose material is then moved into a storage bin 50. In one embodiment of the present invention the sterilized cellulose material is moved from the autoclave 45 into the storage bin 50 using a seal auger. In the storage bin 50 other material that is desired to be added as a component of the finished construction material is mixed into the sterilized cellulose material. Measurement instruments are used in the storage bin 50 to obtain a desired weight ratio of cellulose material to added material.

The mixed sterilized cellulose material and added material is then conveyed to an extruder 55 used to shape the material into construction material. For example, the mixed sterilized cellulose material and added material can be used to produce railroad ties that conform to standard railroad tie specifications.

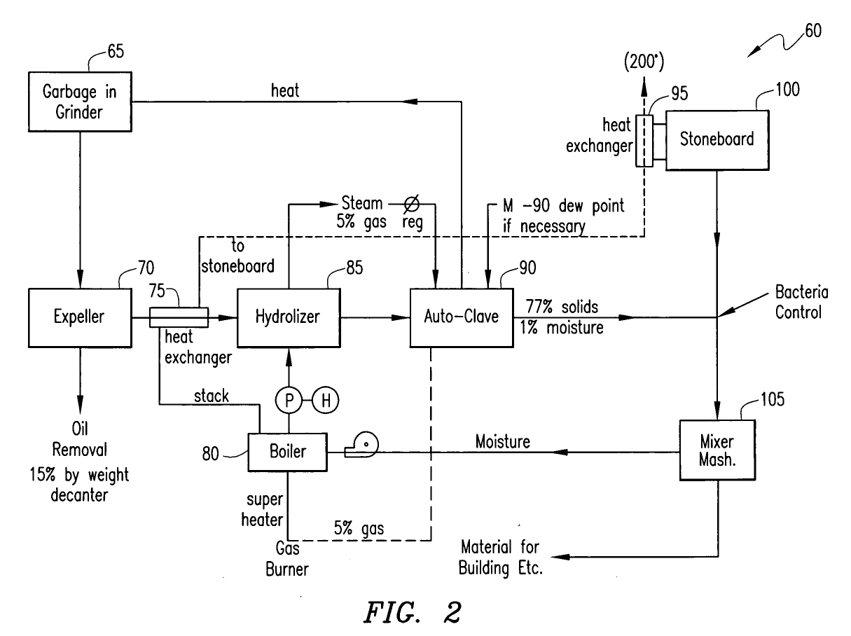

Referring now to FIG. 2, another embodiment of a waste processing system for processing waste material to produce construction material is illustrated. In the waste processing system of FIG. 2, waste material, such as garbage comprised of water, oil, organic substances, solids, cellulose, metal, and glass, is collected and fed into a grinder 65 which grinds the waste material into a homogenous mixture of waste material. The waste material mixture is then fed into an expeller 70 which removes oil from the waste material mixture. The waste material mixture is fed into a first heat exchanger 75 that receives heat from an exhaust stack of a boiler 80 heated by a gas burner. The first heat exchanger 75 serves to heat the waste material mixture before it is passed to a hydrolizer 85 that is fed superheated steam generated by the boiler 85. The combination of the waste material mixture and superheated steam produces a cellulose material mixture. The cellulose material mixture is then fed into an autoclave 90, which receives steam from the hydrolizer 85, where the cellulose material mixture is purified and sterilized to remove bacteria. Waste gas from the autoclave 90 can optionally be provided to the gas burner of the boiler 80. In addition, heat from the autoclave 90 can be provided to heat the grinder 65.

Heat from the first heat exchanger 75 can optionally be provided to a second heat exchanger 95 used to heat a stoneboard mixture 100. The stoneboard mixture and sterilized cellulose material are then fed into a mixer/masher 105. The mixer/masher 105 mixes the stoneboard mixture and sterilized cellulose material. Moisture is removed from the mixture and used to feed the boiler 80. The resultant mixture is then mashed and formed into construction material, such as material used for building, etc.

The waste processing system of the present invention allows for the recycling of waste material to produce construction material. One advantage of the waste processing system of the present invention is a reduction in the need for landfills, as well as the cost associated with the storage of waste material.

Although a preferred embodiment of the system and method of the present invention has been illustrated in the accompanying Drawings and described in the foregoing Detailed Description, it is understood that the invention is not limited to the embodiment disclosed, but is capable of numerous rearrangements, modifications, and substitutions without departing from the spirit of the invention as set forth and defined by the following claims.

What is claimed is:

1. A system for processing waste material, the system comprising:
means for separating waste material into a solid component, and a liquid and tissue component;
means for separating the liquid and tissue component into a liquid component and a tissue component;
means for mixing the solid component and the tissue component to form a solid and tissue mixture;
means for combining the solid and tissue mixture and superheated steam to form a cellulose material; and
means for extruding the cellulose material to form a construction material.

2. The system of claim 1, wherein the means for separating waste material into a solid component and a liquid and tissue component comprises a grid system.

3. The system of claim 1, wherein the means for separating the liquid and tissue component into a liquid component and a tissue component comprises a centrifuge.

4. The system of claim 1, wherein the means for mixing the solid component and the tissue component to form a solid and tissue mixture comprises a mixer.

5. The system of claim 1, wherein the means for combining the solid and tissue mixture and superheated steam comprises a hydrolizer.

6. The system of claim 1, wherein the means for extruding the cellulose material comprises an extruder.

7. The system of claim 1, further comprising:
means for processing the solid component prior to mixing the solid component and the tissue component.

8. The system of claim 7, wherein the means for processing the solid component comprises a hammer mill.

9. The system of claim 1, further comprising:
means for sterilizing the cellulose material prior to extruding the cellulose material.

10. The system of claim 9, wherein the means for sterilizing the cellulose material comprises an autoclave.

11. The system of claim 1, further comprising:
means for mixing additional material with the cellulose material prior to extruding the cellulose material.

12. The system of claim 1, further comprising:
means for boiling the liquid component to produce the superheated steam.

13. The system of claim 12, wherein the means for boiling the liquid component comprises a boiler.

14. A method of processing waste material, the method comprising the steps of:
separating waste material into a solid component, and a liquid and tissue component;
separating the liquid and tissue component into a liquid component and a tissue component;
mixing the solid component and the tissue component to form a solid and tissue mixture;
combining the solid and tissue mixture and superheated steam to form a cellulose material; and
extruding the cellulose material to form a construction material.

15. The method of claim 14, further comprising the step of:
processing the solid component prior to the step of mixing the solid component and the tissue component.

16. The method of claim 14, further comprising the step of:
sterilizing the cellulose material prior to the step of extruding the cellulose material.

17. The method of claim 14, further comprising the step of:
mixing additional material with the cellulose material prior to the step of extruding the cellulose material.

18. The method of claim 14, further comprising the step of:
boiling the liquid component to produce the superheated steam.
